(19) United States
(12) Patent Application Publication
(10) Pub. No.: US 2026/0310133 A1
(43) Pub. Date: Oct. 8, 2026

(54) DEVICE WITH ADJUSTABLE LATERAL STOP FOR A HOROLOGY MOVEMENT

(71) Applicant: The Swatch Group Research and Development Ltd, Marin-Epagnier (CH)

(72) Inventors: Dominique LECHOT, Les Reussilles (CH); Jérôme Favre, Neuchâtel (CH); Pascal Winkler, St-Blaise (CH)

(73) Assignee: The Swatch Group Research and Development Ltd, Marin-Epagnier (CH)

(21) Appl. No.: 19/561,781

(22) Filed: Mar. 10, 2026

(30) Foreign Application Priority Data
Apr. 3, 2025 (EP) 25168336.3

(51) Int. Cl. G04B 43/00; G04B 17/04; G04B 31/02

(52) U.S. Cl. CPC G04B 43/002; G04B 17/045; G04B 31/02

(57) ABSTRACT

A device with an adjustable lateral stop (1, 20) for a horology movement, in particular a resonator mechanism with a rotationally flexible guide. The device includes a block (2) with a bed (3) and a wall (4) with a first hole (5), and a mobile element (10) arranged in the bed (3) above the wall (4). The mobile element (10) has a hole (11) and is arranged so that the second hole (11) is facing the first hole (5) to allow the passage of a mobile body (6) through the first hole and the second hole so as to be held laterally by the mobile element (10), the mobile element (10) being configured such that the second hole (11) can have a plurality of positions, in which the second hole (11) radially off-centre relative to the first hole (5).

### CROSS-REFERENCE TO RELATED APPLICATIONS

This application claims priority to European Patent Application No. 25168336.3, filed on Apr. 3, 2025, the entire contents of which are incorporated herein by reference.

### TECHNICAL FIELD OF THE INVENTION

The invention relates to a device with an adjustable lateral stop for a horology movement, in particular for a resonator mechanism with a rotationally flexible guide.

### Technological background

Torsional rigidity of the suspension is a critical point for most horology oscillators comprising at least one balance spring or resilient blades that form a flexible guide, and particularly for crossed-blade resonators. Shock resistance also depends on this torsional rigidity; indeed, in a shock, the stress on the blades quickly reaches very high levels, which reduces the travel that the part can complete before breaking. Shock absorbers for timepieces come in many variations. However, their main purpose is to protect the fragile pivots on the resonator axis, and not the resilient elements, such as a conventional balance spring.

New mechanism architectures maximise the quality factor of a resonator by using a flexible guide in conjunction with a pallet escapement with a small lift angle, according to application EP18168765 or application EP3561607 granted to ETA Manufacture Horlogère Suisse and its variants, the teachings of which can be directly used in the present invention, and whose resonator can be further improved with respect to its sensitivity to shocks, in certain particular directions. The aim is to keep the blades from breaking when subjected to shocks.

Devices with axial stops are available to protect flexible blades, in particular to keep them from breaking. They generally comprise a pin fitted to the balance and a fixed axial stop fitted to a bar in the movement, for example the balance cock.

Some devices may also comprise a lateral stop, in which the pin is further configured to pass through a hole in a wall acting as a lateral stop.

However, the wall, and therefore the hole, must be precisely positioned to avoid unwanted contact. The precision with which these elements are positioned is important for effective protection, while maintaining adequate safety distances. However, lack of precision in these positions entails substantial safety distances, which reduce the protection of the flexible guide.

### SUMMARY OF THE INVENTION

The invention aims to facilitate the positioning of the device with a lateral stop to reduce the minimum safety distances.

To this end, the invention relates to a device with an adjustable lateral stop for a horology movement, in particular a resonator mechanism with a rotationally flexible guide, the device comprising a block with a bed and a wall with a first hole.

The invention is characterised in that it comprises a mobile element arranged in the bed above the wall, the mobile element having a second hole, the mobile element being arranged so that the second hole is facing the first hole to allow the passage of a mobile body through the first hole and the second hole so as to be held laterally by the mobile element, the mobile element being configured such that the second hole can have a plurality of positions, in which the second hole is more or less radially off-centre relative to the first hole depending on the position.

The position of the second hole can therefore be adjusted relative to a mobile body, such as a pin on the balance, so that it is centred in the second hole. With the invention, the safety distances from the pin can be reduced, as it is well centred.

According to a particular embodiment of the invention, the mobile element is angularly mobile, such that the axis of the second hole is angularly mobile around the axis of the first hole.

According to a particular embodiment of the invention, the first and second holes are facing each other, irrespective of the position of the mobile element.

According to a particular embodiment of the invention, the mobile element comprises an outer ring and an inner ring, the inner ring being arranged inside the outer ring, the inner ring comprising the second hole.

According to a particular embodiment of the invention, the inner ring is off-centre relative to the outer ring.

According to a particular embodiment of the invention, the second hole is off-centre relative to the inner ring.

According to a particular embodiment of the invention, the first hole is centred in the wall of the block.

According to a particular embodiment of the invention, the second hole has a smaller diameter than that of the first hole.

According to a particular embodiment of the invention, the outer ring comprises flexible arms bearing against the block to induce a positioning couple.

According to a particular embodiment of the invention, the outer ring comprises a first circular outer outline centred relative to the first hole, and a first circular inner outline off-centre relative to the first hole.

According to a particular embodiment of the invention, the inner ring comprises a second circular outer outline off-centre relative to the first hole, the second outer outline corresponding to the first inner outline of the outer ring.

According to a particular embodiment of the invention, changing the angular position of the inner ring relative to the outer ring changes the radial position of the second hole relative to the first hole.

According to a particular embodiment of the invention, simultaneously changing the angular position of the outer ring and of the inner ring in the bed relative to the block changes the angular position of the second hole relative to the first hole.

According to a particular embodiment of the invention, the device comprises an axial stop arranged in the bed above the second hole.

The invention also relates to a horology movement comprising a regulating organ fitted with a balance and with a balance return spring, such as a flexible guide, the horology movement comprising such a device with an adjustable lateral stop, the balance being fitted with a mobile body that can be held laterally through the first and second holes.

### BRIEF DESCRIPTION OF THE FIGURES

The purposes, advantages and characteristics of the invention will be better understood on reading the following detailed description, with reference to the appended drawings, in which:

FIG. 1 is a schematic representation of a perspective view of a device with an adjustable lateral stop according to a first embodiment of the invention;

FIG. 2 is a schematic representation of a cross-sectional view of the device with an adjustable lateral stop in FIG. 1;

FIG. 3 is a schematic representation of an exploded perspective view of the device with an adjustable lateral stop in FIG. 1;

FIG. 4 is a schematic representation of a top view of the adjustment part of the device with an adjustable lateral stop in FIG. 1;

FIG. 5 is a schematic representation of a cross-sectional perspective view of the adjustment part in FIG. 4 in a first configuration;

FIG. 6 is a schematic representation of a cross-sectional perspective view of the adjustment part in FIG. 4 in a second configuration; and

FIG. 7 is a schematic representation of a top view of a device with an adjustable lateral stop according to a second embodiment of the invention.

### DETAILED DESCRIPTION OF THE INVENTION

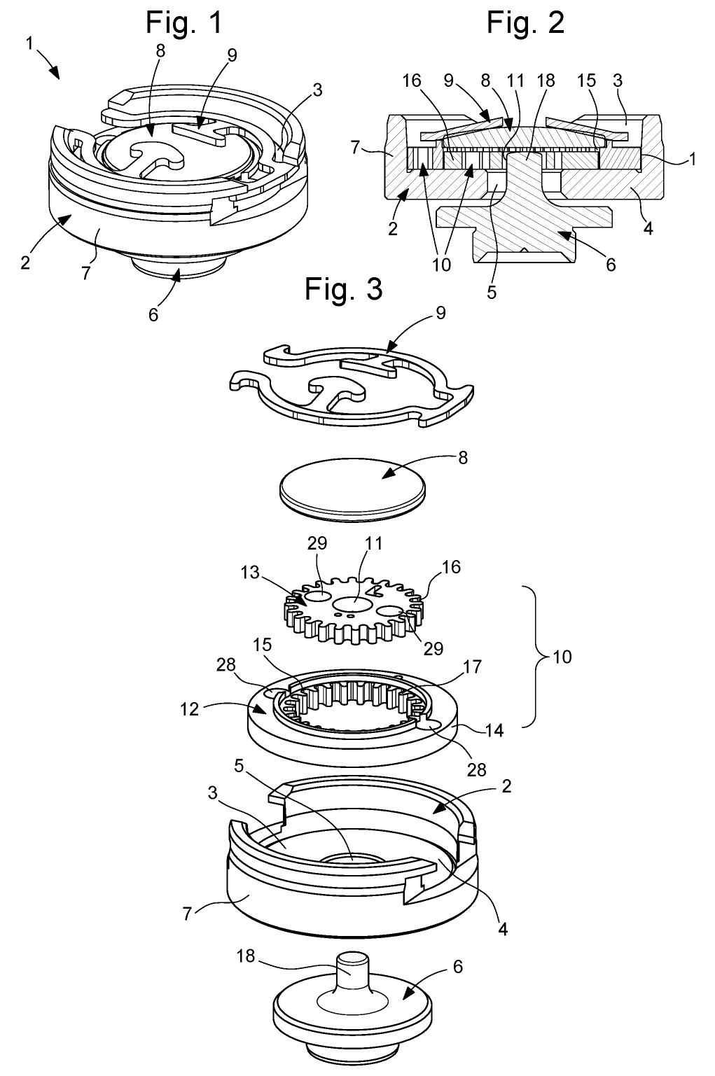

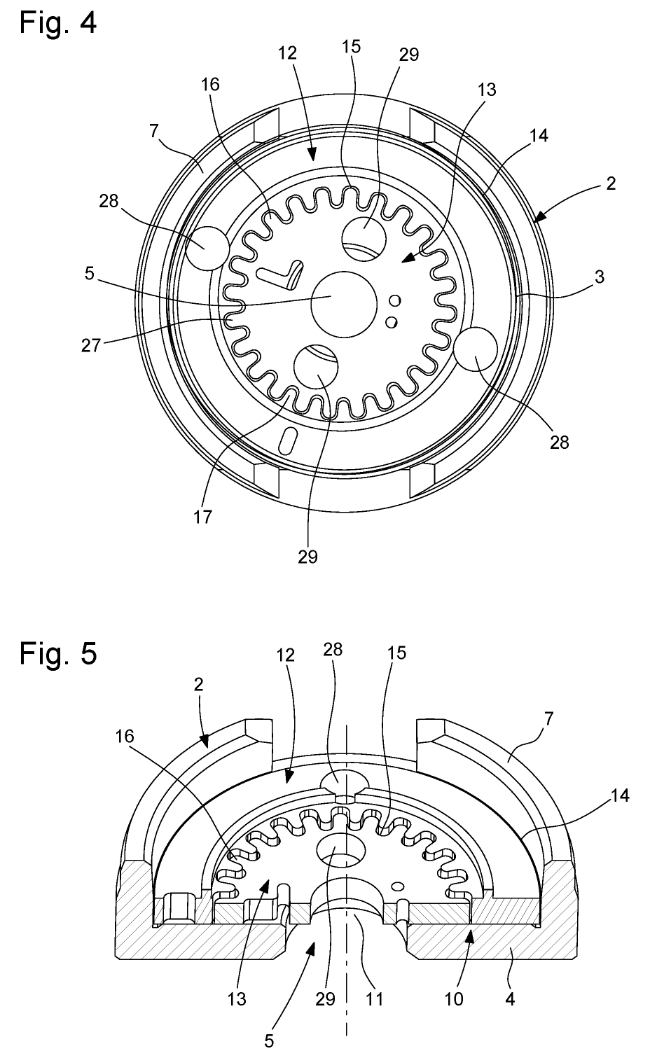

In FIGS. 1 to 3, the invention relates to a first embodiment of a device with an adjustable lateral stop 1 for a horology movement.

The device with an adjustable lateral stop 1 comprises a block 2 with a bed 3, preferably circular, a wall 4 with a first hole 5 to allow the passage of a mobile body 6. The mobile body 6 comprises a pin 18, for example. The mobile body 6 is fitted, for example, on a balance of a regulating organ in the horology movement. The wall 4 forms the back of the bed 3, and the block 2 comprises a peripheral flange 7 delimiting the bed 3.

The bed 3 is preferably cylindrical, and the peripheral flange 7 is substantially circular.

The device with an adjustable lateral stop 1 also comprises an axial stop 8 arranged in the bed 3. The axial stop 8 acts to hold the pin 18 when it meets the axial stop 8. Thus, in case of a shock, the pin 18 meets the axial stop 8, and the component carrying the pin 18 is locked in this direction.

The device with an adjustable lateral stop 1 further comprises a spring 9 bearing on the axial stop 8, arranged above the axial stop 8. The spring 9 is secured in the bed 3 at least partially above the axial stop 8 to hold it.

According to the invention, the device with an adjustable lateral stop 1 comprises a mobile element 10 with a second hole 11. The axial stop 8 is arranged in the bed 3 above the mobile element 10.

The mobile element 10 is arranged in the bed 3 above the wall 4, such that the second hole 11 faces the first hole 5. The mobile body 6 can therefore pass through the first hole 5 and the second hole 11 so as to be held laterally by the mobile element 10.

The mobile element 10 is rotationally mobile, such that the second hole 11 can have a plurality of positions above the first hole 5. Depending on the positions of the mobile element 10 in the bed, the axis of the second hole A2 is more or less off-centre relative to the axis of the first hole A1.

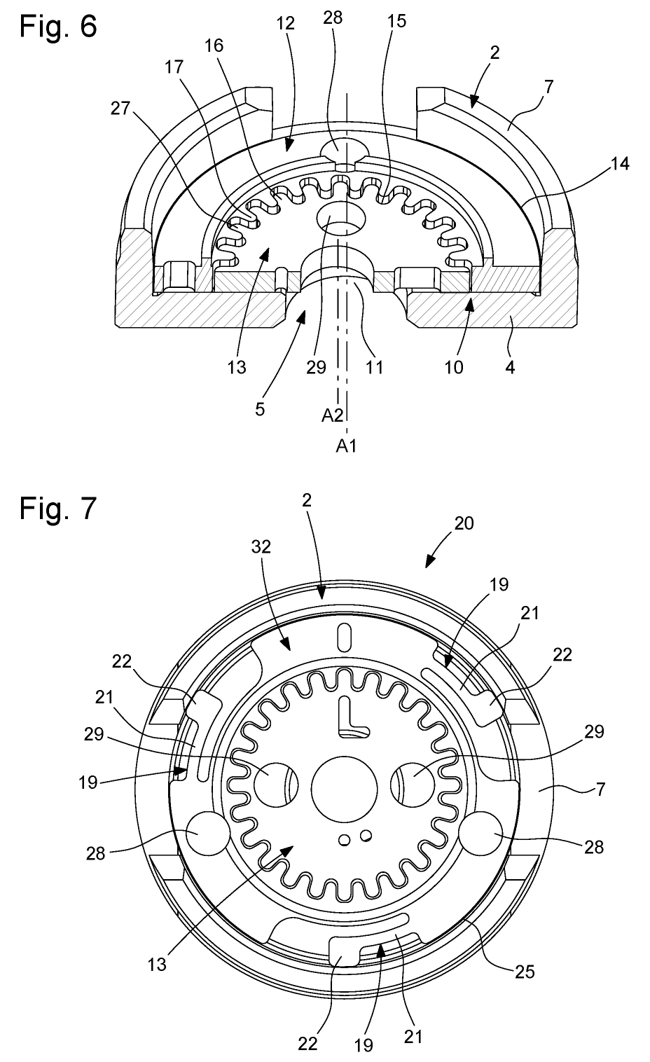

Preferably, the axis of the second hole A2 can have positions ranging from a position centred on the axis of the first hole A1 to a substantially off-centre position relative to the axis of the first hole A1, as shown in FIGS. 5 and 6.

Preferably, irrespective of its position, the second hole 11 is always facing the first hole 5, even if they are off-centre relative to each other. The mobile body 6 can thus pass through both holes, irrespective of the position of the second hole 11.

The mobile element 10 comprises an outer ring 12 and an inner ring 13. The inner ring 13 comprises the second hole 11. The inner ring 13 is arranged inside the outer ring 12. Both rings are arranged in the same plane, and preferably have a flat ring shape.

The outer ring 12 comprises a first circular outer outline 14. The first outer outline 14 corresponds to the diameter of the bed 3 and is centred relative to the first hole 5.

The outer ring 12 comprises a first circular inner outline 15. The first inner outline 15 is off-centre relative to the first hole 5, that is, to the axis of the first hole A1.

The inner ring 13 comprises a second circular outer outline 16 corresponding to the first inner outline 15 of the outer ring 12. The second outer outline 16 is therefore also off-centre relative to the first hole 5.

Moreover, the second hole 11 is off-centre relative to the second outer outline 16. In other words, the second hole 11 is off-centre on the inner ring 13.

The inner ring 13 is thus off-centre relative to the outer ring 12, and the second hole 11 is off-centre relative to the inner ring 13.

As a result, the second hole 11 can have a plurality of positions, the axis of the second hole A2 being more or less off-centre relative to the axis of the first hole A1 depending on the positions of the mobile element in the bed 3.

More specifically, the plurality of positions depends on the positioning of the inner ring 13 relative to the outer ring 12.

In fact, as the second outer outline 16 of the inner ring 13 is off-centre relative to the first hole 5, turning the inner ring 13 moves the axis of the second hole A2 towards or away from the axis of the first hole A1, depending on its angular position relative to the first hole 5 as well as to the outer ring 12.

Thus, changing the angular position of the inner ring 13 relative to the outer ring 12 changes the radial position of the axis of the second hole A2 relative to the axis of the first hole A1.

FIGS. 5 and 6 show two end positions of the inner ring 13, one in which the axis of the first hole A1 and the axis of the second hole A2 are coaxial, and the other in which the axis of the second hole A2 is off-centre relative to the axis of the first hole A1.

In this embodiment, the first inner outline 15 of the outer ring 12 has a first toothing 17, and the second outer outline 16 of the inner ring 13 has a second toothing 27 for engaging with the first toothing 17. Both toothings are configured to engage to lock the position of the inner ring 13 relative to the outer ring 12. This means that if one ring is turned, the other is driven and turns with it.

The toothings enable the rings to be positioned relative to each other. In fact, the rings can be separated and reassembled in a different angular orientation to each other. This changes the position of the second hole 11 relative to the first hole 5, and therefore the position of the axis of the second hole A2 relative to that of the first hole 5. Each tooth in the toothing induces a different angular position between the two rings, and therefore a different offset between the axes of the two holes.

Furthermore, in addition to adjusting the radial position of the axis of the second hole A2, its angular position can also be changed by rotating the two inner rings 13 and outer ring 12 together in the bed 3.

These two adjustments enable the second hole 11 to be optimally arranged around the pin 18 or around the pin axis, in particular so that the space around it is substantially the same. The pin 18 is then centred relative to the second hole 11, which makes it possible to have a second hole that is narrower than in a conventional device without this type of adjustment.

To pivot the inner 13 and outer 12 rings, the rings comprise openings 28, 29, for example two each, that are arranged on either side of the second hole 11 and of the first inner outline 15. These openings 28, 29 allow a tool to be inserted to engage the rings.

In FIG. 7, the second embodiment of the device with an adjustable lateral stop 20 comprises flexible arms 19 arranged on the first outer outline 25 of the outer ring 32, so as to bear against the peripheral wall 7 of the block 2 to produce a positioning couple on the block 2. This prevents the outer ring 32 from turning inadvertently and keeps it in its angular position. The flexible arms 19 comprise a flexible strand 21, preferably curved, and a pallet stone 22 arranged at the free end of the flexible strand 21 to come into contact with the block 2. The flexible arms 19, in this example three, are distributed around the first outer outline 14 and extend in the plane of the outer ring 12. The flexible arms 19 exert pressure against the peripheral wall 7 of the block 2.

Naturally, the invention is not limited to the embodiments described with reference to the figures, and variants could be envisaged without departing from the scope of the invention.

1. A device with an adjustable lateral stop (1, 20) for a horology movement, in particular a resonator mechanism with a rotationally flexible guide, the device comprising:
a block (2) with a bed (3) and a wall (4) with a first hole (5); and
a mobile element (10) arranged in the bed (3) above the wall (4), the mobile element (10) having a second hole (11), and being arranged so that the second hole (11) is facing the first hole (5) to allow the passage of a mobile body (6) through the first hole (5) and the second hole (11) so as to be held laterally by the mobile element (10), the mobile element (10) being configured such that the second hole (11) can have a plurality of positions, in which the second hole (11) is radially off-centre relative to the first hole (5).

2. The device with an adjustable lateral stop according to claim 1, wherein the mobile element (10) is angularly mobile, such that the axis of the second hole (A2) is angularly mobile around the axis of the first hole (A1).

3. The device with an adjustable lateral stop according to claim 1, wherein the first hole (5) and the second hole (11) are facing each other, irrespective of the position of the mobile element (10).

4. The device with an adjustable lateral stop according to claim 1, wherein the mobile element (10) comprises an outer ring (12, 32) and an inner ring (13), the inner ring (13) being arranged inside the outer ring (12, 32), the inner ring (12) comprising the second hole (11).

5. The device with an adjustable lateral stop according to claim 4, wherein the inner ring (13) is off-centre relative to the outer ring (12, 32).

6. The device with an adjustable lateral stop according to claim 4, wherein the second hole (11) is off-centre relative to the inner ring (13).

7. The device with an adjustable lateral stop according to claim 4, wherein the outer ring (12, 32) comprises a first circular outer outline (14) centred relative to the first hole (5), and a first circular inner outline (15) off-centre relative to the first hole (5).

8. The device with an adjustable lateral stop according to claim 7, wherein the inner ring comprises a second circular outer outline (16) off-centre relative to the first hole (5), the second outer outline (16) corresponding to the first inner outline (15) of the outer ring (12, 32).

9. The device with an adjustable lateral stop according to claim 4, wherein changing the angular position of the inner ring (13) relative to the outer ring (12, 32) changes the radial position of the second hole (11) relative to the first hole (5).

10. The device with an adjustable lateral stop according to claim 4, wherein simultaneously changing the angular position of the outer ring (12, 32) and of the inner ring (13) in the bed (3) relative to the block (2) changes the angular position of the second hole (11) relative to the first hole (5).

11. The device with an adjustable lateral stop according to claim 4, wherein the outer ring (32) comprises flexible arms (19) bearing against the block (2) to induce a positioning couple.

12. The device with an adjustable lateral stop according to claim 4, wherein the first hole (5) is centred in the wall (4) of the block (2).

13. The device with an adjustable lateral stop according to claim 4, wherein the second hole (11) has a smaller diameter than that of the first hole (5).

14. The device with an adjustable lateral stop (1, 20) according to claim 4, further comprising an axial stop (8) arranged in the bed (3) above the second hole (11).

15. A horology movement comprising a regulating organ fitted with a balance and with a balance return spring, such as a flexible guide, wherein the movement comprises a device with an adjustable lateral stop (1, 20) according to claim 1, the balance being fitted with a mobile body (6) that can be held laterally through the first (5) and second (11) holes.
